(19) United States
(12) Patent Application Publication
(10) Pub. No.: US 2004/0070605 A1
(43) Pub. Date: Apr. 15, 2004

(54) Method and system for customizing personal page

(76) Inventors: Chien-Chung Huang, Hsin-Chu City (TW); Tien-Der Chiang, Da-Li City (TW); Shu-Fan Liu, Hsin-Chu City (TW); Chun-Yi Chen, Jian Shiang Huanlie (TW); Yueh-Ching Lee, Jungli City (TW); Yi-Ling Huang, Keelung (TW)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/269,655

(22) Filed: Oct. 11, 2002

(51) Int. Cl. G09G 5/00

(52) U.S. Cl. 345/744

(57) ABSTRACT

A method and system of providing customization options for a portal user interface are provided. New content that may be selected for addition to a customized portal user interface associated with the user are identified for a user in a graphical user interface separately from previously available content that may be selected for addition to the customized portal user interface. If a selection is received of at least a part of the new content for addition to the customized portal user interface associated with the user, a user profile identifying content to be included in the customized portal user interface associated with the user is updated.

### FIELD OF THE INVENTION

The present invention relates generally to computer networks and the like, and more particularly to systems and methods for customizing user interfaces available through computer networks.

### BACKGROUND OF THE INVENTION

Current network platforms, such as the Internet, local area networks (LANs) and wide area network (WANs), generally provide users with access to large quantities of content and available functionality through organized portals. A common example is a portal accessible by an employee through his or her employer's intranet that provides the employee access to company news, address books, approved company forms, information about employee services, training tools, registration forms for company events, various office tools and the like. Similarly, a company's customers may access customer-related content through a customer portal available on the World Wide Web (WWW).

The employee or customer may be associated with a user name and password that allow the employee or customer to access the portal and/ or to access a version of the portal customized to the individual user. For example, the portal may provide access to a master list of all customizable features in the form of, for example, a master checklist of available features. The master list identifies available content that can be selected by the user for inclusion in the user's customized portal user interface. The user's selections are stored and associated with the user. Each time the user logs into the portal, the user's selected profile is used to customize the portal interface for the user. In this manner, the user can eliminate content that the user feels is unnecessary and customize the portal format to maximize the user's experience and needs. There may also be some content that is included in the portal page regardless of user personalization, and this content is displayed to the user along with the user's selected content.

One problem with the aforementioned customization technique and approach is that the user is presented with a master list of dozens or more customizable options. This approach makes it difficult, if not impossible, for the user to quickly identify from the master list new customizable features, e.g., content recently made available for addition to a customized portal user interface. Therefore, there remains a need for a new method and system of personalizing user pages and providing customization options to a user.

### SUMMARY OF THE INVENTION

A method and system of providing customization options for a portal user interface are provided. New content that may be selected for addition to a customized portal user interface associated with the user are identified for a user in a graphical user interface separately from previously available content that may be selected for addition to the customized portal user interface. If a selection is received of at least a part of the new content for addition to the customized portal user interface associated with the user, a user profile identifying content to be included in the customized portal user interface associated with the user is updated.

The system includes at least one processor configured to provide a graphical user interface identifying for a user new content that may be selected for addition to a customized portal user interface associated with the user separately from previously available content that may be selected for addition to the customized portal user interface. The system is also configured to update a user profile identifying content to be included in the customized portal user interface associated with the user if a selection is received of at least a part of the new content for addition to the customized portal user interface associated with the user.

The method and system of providing customization options allow the user to quickly identify new customization features available to the user for the user's personal user interface. The user is quickly alerted to the availability of new content, such as new formatting features, tools and available information, available for inclusion in the user's customized portal interface, and the user can select desired new content without reviewing an entire master list of options. In this manner, the overall user experience is greatly enhanced, while insuring that the user is informed of new options available to the user.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is a stylized overview of a system of interconnected computer networks;

FIG. 2 is a flow diagram of an exemplary method of providing customization options for a portal user interface and method of displaying the interface;

FIG. 3 is an illustration of a non-customized portal page identifying new content available for addition to a customized portal user interface;

FIG. 3A is an illustration of a customized portal page generated according to an updated user profile; and

FIG. 4 is an illustration of a master list of available customizable options associated with the examples of FIGS. 3 and 3A.

### DETAILED DESCRIPTION

The Internet is a worldwide system of computer networks - a network of networks in which a user at one computer can obtain information from any other computer and communicate with users of other computers. The most widely used part of the Internet is the World Wide Web (often-abbreviated “WWW” or called “the Web”). One of the most outstanding features of the Web is its use of hypertext, which is a method of cross-referencing. In most Web sites, certain words or phrases appear in text of a different color than the surrounding text. This text is often also underlined. Sometimes, there are buttons, images or portions of images that are “clickable.” Using the Web provides access to millions of pages of information. Web “surfing” is done with a Web browser, the most popular of which presently are Netscape Navigator and Microsoft Internet Explorer. The appearance of a particular website may vary slightly depending on the particular browser used. Recent versions of browsers have “plug-ins,” which provide animation, virtual reality, sound and music.

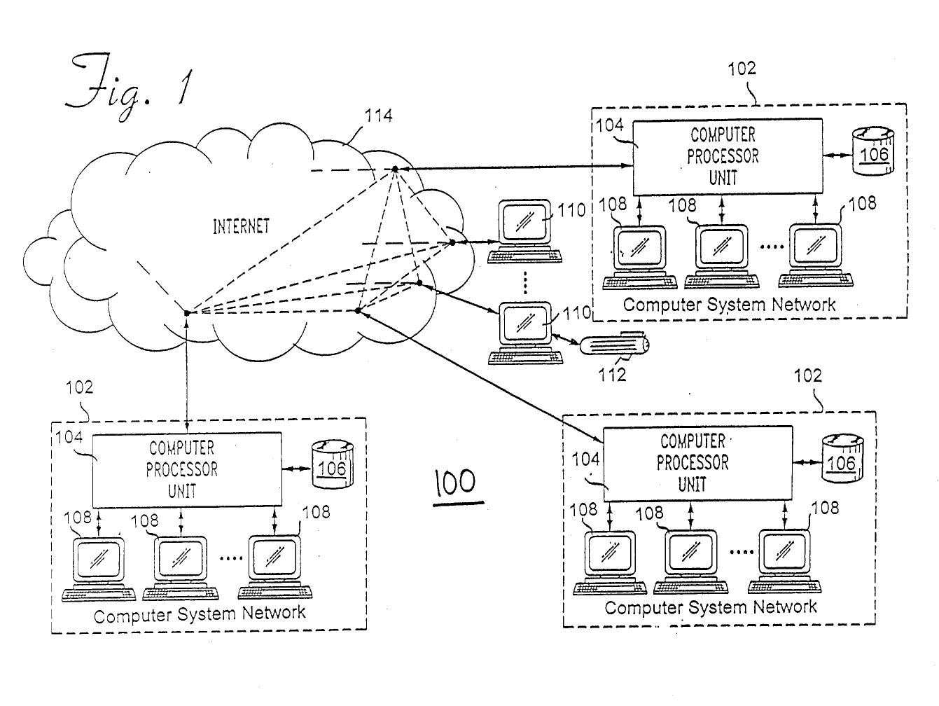

FIG. 1 shows a system 100 of interconnected computer system networks 102. Each computer system network 102 contains a corresponding local computer processor unit 104, which is coupled to a corresponding local data storage unit 106, and local network user terminals 108. A computer system network 102 may be a local area network (LAN) or part of a wide area network (WAN), for example. The local computer processor units 104 are selectively coupled to a plurality of user devices 110 through Internet 114 described above. Each of the plurality of user devices 110 and local user terminals 108 (collectively, user terminals) may have various devices connected to their local computer systems, such as scanners, barcode readers, printers, finger print scanners, mouse devices, and other interface devices 112.

A user device 110, programmed with a Web browser or other software, locates and selects (such as by clicking with a mouse) a particular Web page, the content of which is located on the local data storage unit 106 of a computer system network 102, in order to access the content of the Web page. The Web page may contain links to other computer systems and other Web pages.

The user device 110 may be a microprocessor-based computer terminal, a pager that can communicate through the Internet using the Internet Protocol (IP), a Kiosk with Internet access, a connected personal digital assistant or PDA (e.g., a PALM device manufactured by Palm, Inc.) or other device capable of interactive network communications, such as an electronic personal planner. User device 110 may also be a wireless device, such as a hand-held unit (e.g., cellular telephone) that connects to and communicates through the Internet using the wireless access protocol (WAP).

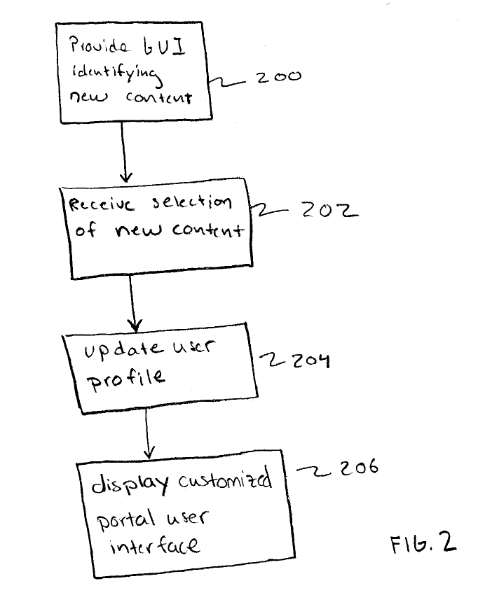

Referring to FIG. 2 a method of providing customization options is illustrated. A user accesses a computer processor unit 104 that provides, for example, an employee or customer portal interface using a user terminal 110 or 108 through Internet 114, a LAN or WAN, or combination thereof. The processor unit 104 provides a graphical user interface (GUI) to the user's terminal at step 200 in the form of, for example, a Web page that is displayed using a browser program local to the user terminal. The graphical user interface (GUI) is preferably a portal page that includes various content retrieved from a data storage unit 106. For example, in the customer context, the GUI may be a customer page that provides content including company information, industry news, weather, forecasts, stock quotes, links to other Web sites and Web pages and tools such as shipping tracking, order status, order placement, etc. As used herein, “portal” is not limited to general purpose Internet portals, such as YAHOO! or GOPHER but also includes GUIs that are of interest to specific, limited audiences, such as the aforementioned employee or customer examples, and that provide the user access to a plurality of different kinds of related or unrelated information, links and tools.

Each user is associated with a user profile stored in data storage unit 106. The user profile identifies how the portal user interface provided by computer processor unit 104 is to be personalized or customized for the respective user. The user profile identifies what content from all available portal content should be included and not included in the user's customized portal user interface.

If the user is prompted to log into the system, such as with a user name and password, before the GUI is displayed at step 200, the GUI displayed at step 200 is preferably the user's customized portal user interface generated according to the user profile associated with the user via the user's user name. If the user is not prompted to login to the system before step 200, a generic portal user interface may be provided, i.e., an interface that is not customized to any particular user.

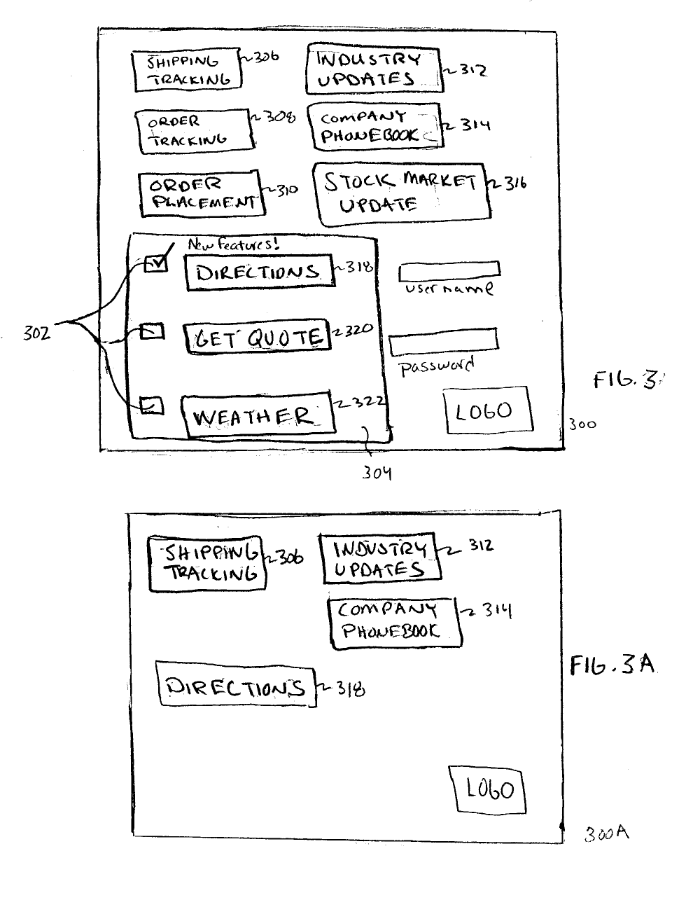

Regardless of whether the user logs into the system before step 200, the GUI provided at step 200 identifies new content that may be selected by the user for addition to the customized portal user interface associated with the user. The new content is preferably identified separate from or in isolation from an identification of previously available content that may be selected by the user for addition to the customized portal user interface, i.e., not as an indistinguishable part of a master list identifying all content, new or previously available, that may be added or selected for display by the user in the user's customized portal user interface. For example, as shown in FIG. 3, a portion 304 of the GUI 300 displayed to the user may list or describe new content that may be added to the user's customized portal interface. Of course, other manners of separately identifying the new content are also appropriate, such as by distinguishing the new content from a previously available content in a combined master list of available content by font or color or size or other indicia, for example, or combination thereof.

As shown in the GUI 300 of FIG. 3, the graphical identification of the new content 304 newly available for addition to a customer's customized portal user interface preferably prompts the user to select any new content that the user desires to have added to the user's customized portal interface. One exemplary manner of prompting the user is through selectable check boxes 302 displayed next to an identification of each available new content, such as “Directions” tool 318, “Price Quote” tool 320 and “Weather” forecast 322. Also shown in GUI 300 is the display of previously available content, such as “Shipping Tracking” 306, “Order Tracking” 308, “Order Placement” 310 and “Industry Updates” 312, “Company Phonebook” 314, and “Stock Market Update” 316. GUI 300 also includes user name and password windows.

The computer processor unit 104 receives any selection of new content, and the computer processor unit 104 updates the user's profile at step 204 to reflect the selection. For example, again referring to FIG. 3, the check box adjacent to Directions 318 is shown “checked,” indicating the user's selection of the Directions feature for addition to the user's customized portal user interface. If the user has not logged into the system as of step 202, the user is then prompted to login with the user's username and password so that the correct profile may be updated. After the user's profile is updated at step 204, the user's customized portal user interface is provided at step 206 for display to the user according to the updated profile. FIG. 3A shows GUI 300A, which is the user's customized portal user interface, provided by the computer processor unit 104 for display to the user according to the user's updated profile, which indicates Directions 318 as being selected for addition to the customized portal user interface. It should be apparent from FIG. 3A that the user's profile before being updated identifies Shipping Tracking 306, Industry Updates 312 and Company Phonebook 314 as part of the user's customized portal user interface.

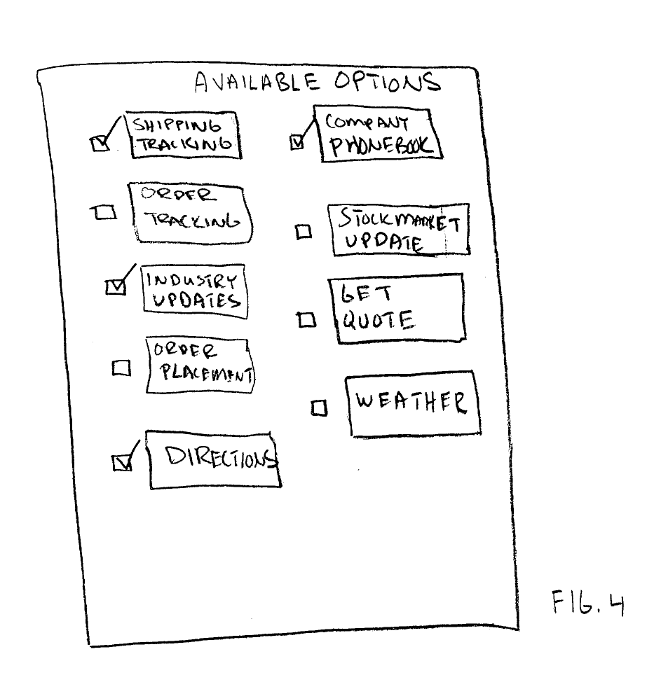

In order to identify separately the new content for the user, a determination must be made as to what qualifies as new content as opposed to previously available content. This determination may be made in several different ways. Each content (e.g., textual content, links, tools, etc.) in data storage unit 106 is preferably associated with a time stamp indicating the date the respective content was made available for selection by a user. In one embodiment, the system via computer processor unit 104 identifies new content as that content having a time stamp within a fixed period of time prior to providing the graphical user interface at step 200 (i.e., prior to the current date or time). For example, all content having a time stamp within the past two weeks or other time frame may be designated as new content. One problem with using a fixed period, however, is that there is no guarantee that the user has been alerted to content made available to the user before the two week time period. If the user has not accessed the system for three weeks, for example, a week's worth of new content is never separately identified to the user. This content may still be viewed by the user in a master list of available content (FIG. 4) but, as mentioned, is never separately presented or identified to the user in the manner that the new content from the past two weeks is identified.

In an alternative embodiment, new content is defined as content that has been made available for addition to the user's customized portal user interface since the user's last login. A time stamp for the user's last login is retrieved from data storage unit 106 and compared against the time stamps associated with the respective available content. Any content having a time stamp more recent than the user's last login time stamp is classified as new content and identified to the user.

The system preferably still provides the user the option of updating the user's profile via the master list described in the Background of the Invention section and shown in FIG. 4 as relates to the examples of FIGS. 3 and 3A. FIG. 4 shows a master list for the available content for the portal illustrated by FIGS. 3 and 3A and is also representative of the updated user profile (i.e., “Directions” is checked). In this manner, the user is still able to access the master list to add or remove content selection from the user's profile, whether they be new content or previously available content.

The system and method of the present invention may be implemented by utilizing at least a part of the system 100 described above in connection with FIG. 1. It should be apparent to one of ordinary skill that the system may be incorporated in a LAN, in a WAN, or through an Internet 114 based approach, such as through a hosted or non-hosted application service, or through a combination thereof. The functionality of the method may be programmed and executed by at least one computer processor unit 104, with necessary data and graphical interface pages as described hereafter stored in and retrieved from a data storage unit 106. A user can access this functionality using a user device 110 or computer terminal 108.

The methods described herein are equally well suited for use in other network communication systems. For example, the methods are also applicable to pages received and displayed using other interactive platforms, such as interactive television systems. Further, the method and system as described herein are by no means limited by the types of content described above and functionality provided to users.

The present invention can be embodied in the form of methods and apparatus for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention

What is claimed is:

1. A method of providing customization options for a portal user interface, comprising the steps of:
identifying for a user in a graphical user interface new content that may be selected for addition to a customized portal user interface associated with said user separately from previously available content that may be selected for addition to said customized portal user interface; and
updating a user profile identifying content to be included in said customized portal user interface associated with said user if a selection is received of at least a part of said new content for addition to said customized portal user interface associated with said user.

2. The method of claim 1, further comprising the step of displaying said customized portal user interface associated with said user according to said user profile.

3. The method of claim 2, wherein said displaying step includes the step of displaying said customized portal user interface according to an updated user profile updated with said selection.

4. The method of claim 1, wherein said new content includes content made available for addition to said customized portal user interface during a fixed time period prior to being identified in said graphical user interface.

5. The method of claim 1, wherein said new content includes content made available for addition to said customized portal user interface since a last login of said user.

6. The method of claim 5, further comprising the step of comparing a time stamp for said user's last login and a time stamp associated with respective content to identify said new content made available for addition to said customized portal user interface since said user's last login.

7. The method of claim 1, further comprising the step of receiving said selection of at least a part of said new content for addition to said customized portal user interface associated with said user.

8. The method of claim 7, wherein said selection is received from a user terminal through the Internet and said graphical user interface and said customized portal user interface are web pages.

9. The method of claim 1, wherein said identifying step includes the step of displaying a description of said new content in said graphical user interface and prompting said user to select desired new content for addition to said customized portal user interface.

10. The method of claim 9, further comprising the steps of:
prompting said user to login after said user makes said selection; and
displaying said customized portal user interface according to an updated user profile updated with said selection.

11. The method of claim 1, further comprising the steps of:
displaying a description of said new content in said customized portal user interface generated according to a current user profile;
prompting said user to select desired new content for addition to said customized portal user interface; and
redisplaying said customized portal user interface according to an updated user profile updated with said selection.

12. A system for providing customization options for a portal user interface, comprising:
at least one processor, said at least one processor configured to:
provide a graphical user interface identifying for a user new content that may be selected for addition to a customized portal user interface associated with said user separately from previously available content that may be selected for addition to said customized portal user interface; and
update a user profile identifying content to be included in said customized portal user interface associated with said user if a selection is received of at least a part of said new content for addition to said customized portal user interface associated with said user.

13. The system of claim 12, wherein said processor is further configured to provide said customized portal user interface associated with said user according to said user profile.

14. The system of claim 13, wherein said processor is further configured to provide said customized portal user interface according to an updated user profile updated with said selection.

15. The system of claim 12, wherein said new content includes content made available for addition to said customized portal user interface during a fixed time period prior to being identified in said graphical user interface.

16. The system of claim 12, wherein said new content includes content made available for addition to said customized portal user interface since a last login of said user.

17. The system of claim 16, wherein said at least one processor is further configured to compare a time stamp for said user's last login and a time stamp associated with respective content to identify said new content made available for addition to said customized portal user interface since said user's last login.

18. The system of claim 12, wherein said at least one processor is further configured to receive said selection of at least a part of said new content for addition to said customized portal user interface associated with said user.

19. The system of claim 18, wherein said at least one processor is connected to the Internet to receive said selection and said graphical user interface and said customized portal user interface are web pages.

20. The system of claim 12, wherein said graphical user interface provided by said at least one processor displays a description of said new content that may be selected for addition to said customized portal user interface, said at least one processor being further configured to prompt said user to select desired new content for addition to said customized portal user interface.

21. The system of claim 20, wherein said at least one processor is further configured to:
prompt said user to login after said user makes said selection; and
provide said customized portal user interface according to an updated user profile updated with said selection.

22. The system of claim 12, wherein said at least one processor is further configured to:
provide a description of said new content that may be selected for addition to said customized portal user interface in said customized portal user interface generated according to a current user profile;
prompt said user to select desired new content for addition to said customized portal user interface; and
redisplay said customized portal user interface according to an updated user profile updated with said selection.

23. A method of providing a customized portal user interface, comprising the steps of:
identifying for a user in a graphical user interface new content that may be selected for addition to a customized portal user interface associated with said user separately from previously available content that may be selected for addition to said customized portal user interface;
prompting said user to select desired new content for addition to said customized portal user interface;
receiving a selection of at least a part of said new content for addition to said customized user interface associated with said user;
updating a user profile identifying content to be included in said customized portal user interface associated with said user if a selection is received of at least a part of said new content for addition to said customized portal user interface associated with said user; and
providing for display to said user said customized portal user interface associated with said user according to an updated user profile associated with said user.

24. The method of claim 23, wherein said new content includes content made available for addition to said customized portal user interface during a fixed time period prior to being identified in said graphical user interface.

25. The method of claim 23, wherein said new content includes content made available for addition to said customized portal user interface since a last login of said user.

26. The method of claim 25, further comprising the step of comparing a time stamp for said user's last login and a time stamp associated with respective content to identify said new content made available for addition to said customized portal user interface since said user's last login.
